(19) United States
(12) Patent Application Publication
(10) Pub. No.: US 2003/0152359 A1
(43) Pub. Date: Aug. 14, 2003

(54) System and method for improving use of a recording medium of an audio-video (AV) system

(76) Inventor: Jong-phil Kim, Suwon-city (KR)

Correspondence Address: Roylance, Abrams, Berdo & Goodman, L.L.P., Suite 600, 1300 19th Street, Washington, DC, 20036, US

(21) Appl. No.: 10/354,028

(22) Filed: Jan. 30, 2003

(30) Foreign Application Priority Data
Feb. 9, 2002 (KR) 2002-7752

(51) Int. Cl. H04N 5/76

(52) U.S. Cl. 386/46; 386/111

(57) ABSTRACT

A system and method for improving the use of a recording medium of an AV (audio-video) system. The system and method perform the operations of calculating storage capacity remaining in the recording medium, recording to the recording medium, and displaying the storage capacity remaining in the recording medium when the storage capacity remaining in the recording medium is less than a predetermined level. Accordingly, a user can be informed that the storage capacity remaining in the recording medium is less than a predetermined level when the recording is performed in the AV system, and the user can delete files already stored in the recording medium to enable the recording to continuously operate without interruption due to lack of storage space.

This application claims benefit under 35 U.S.C. § 119 from Korean Patent Application No. 2002-7752, filed on Feb. 9, 2002, the entire content of which is incorporated herein by reference.

### BACKGROUND OF THE INVENTION

1. Field of the Invention

The present invention relates to a system and method for improving the use of a recording medium of an AV (audio-video) system. More particularly, the present invention relates to a system and method which can calculate storage capacity of the recording medium of an AV system and notify a user of the storage capacity remaining in the recording medium to inform the user that the storage capacity is less than a predetermined level.

2. Description of the Related Art

Many various AV systems exist, such as televisions, VTRs (video tape recorders), DVD (digital video disc) players, hi-fi systems, portable cassette players, MP3 devices, and so on. Recently, to meet the requirement of various users, a new type of AV system has been developed which includes a DVD player and VTR in one system.

AV systems have been improved to upgrade the quality of audio and video signals they record and reproduce. Therefore, the type of data processing performed by such AV systems has changed from analog to digital. Specifically, these AV systems require accurate compression encoding and decoding of the video and audio signals, as well as an internal recording medium in order to store vast amount of data and retrieve the data.

A hard disk, a CD-ROM (compact disk read-only memory), an erasable optical disk, or a magnetic tape can be used as the recording medium. Currently, the most broadly used recording medium for an AV system is a hard disk.

A hard disk is usually referred to as a drive disk, a hard drive, or a hard disk drive. The hard disk is disk-shaped and is typically made of plastic or metal that is coated with magnetic material and can be read or written to by a head which includes a conductive coil. When data is stored on the hard disk, the disk is generally composed of logical units referred to as clusters. A cluster is not a physical unit formed on the hard disk itself, but rather a logical unit. Hence, the magnitude and configuration of a cluster can vary in accordance with the application or environment in which the data being stored on the hard disk is used.

As can be appreciated by one skilled in the art, a hard disk is widely used as the recording medium in existing computer environments, such as Windows®. When data is stored on the hard disk in a computer environment such as Windows®, a control circuit in the computer compares storage capacity remaining in the hard disk and the amount of the data to be recorded. When the amount of the data to be recorded exceeds the storage capacity remaining in the hard disk, a message stating that the data cannot be recorded due to the lack of the capacity is shown, and the recording operation is stopped.

Unlike the above case, when data that is being consecutively input into the computer is stored on the hard disk, the total amount of the data to be recorded cannot be known in advance. Therefore, the user is informed that there is no more space on the hard disk for recording, and the recording operation is stopped after the empty space available for recording in the hard disk is consumed.

When the user records music, movies, dramas and so on using the AV system, the data is consecutively recorded for a recording period, and hence, the total amount of data to be recorded generally cannot be known in advance. Moreover, the control circuit of the AV system cannot determine that the remaining storage capacity of the recording medium is sufficient for recording, and the user also does not know how much space is needed for recording. Furthermore, even though the user may know the remaining storage capacity of the hard disk in advance, the user would only know this capacity in terms of remaining byte space. Thus, the user would not know the amount of remaining storage capacity in terms of recording time.

Accordingly, when the storage capacity of the recording medium, such as a hard disk, is used up during the recording operation performed by the AV system, the recording operation is suddenly stopped without any warning. This kind of inconvenience often occurs when performing reservation recording, in which a portion of the recording medium is intended to be “reserved” to store data being recorded. Thus, the reservation recording is stopped without completing the operation.

### SUMMARY OF THE INVENTION

The present invention seeks to overcome the above-mentioned problems of the conventional systems and techniques. Accordingly, it is the object of the present invention to provide a system and method for improved the use of a recording medium of an AV system, which can notify a user of available storage capacity of the recording medium during a recording operation, to thus inform the user when the storage capacity is less than a predetermined level.

The above object, along with other objects, are substantially accomplished by a system and method for improving the use a recording medium of an AV system. The system and method perform the operations of calculating storage capacity remaining in the recording medium, recording to the recording medium, and displaying the storage capacity remaining in the recording medium to indicate when the storage capacity remaining in the recording medium is less than a predetermined level. The displaying operation includes the operations of displaying a display to enable a user to determine whether to delete a file previously stored in the recording medium, and recording in the recording space secured by deleting the file previously stored in the recording medium when a command for deleting the recorded file is input after the storage capacity remaining in the recording medium has been consumed.

The storage capacity remaining in the recording medium, a recordable temporal duration, or both, are displayed during the displaying operation, and the recording medium can include a hard disk.

Another example of a system and method for substantially achieving the above objects perform the operations of comparing storage capacity remaining in the recording medium and amount of data to be recorded when reservation recording is performed, and displaying the storage capacity remaining in the recording medium when the storage capacity remaining in the recording medium is less than the amount of the data to be recorded. The displaying operation displays information relating to at least one of the following: whether to cancel the reservation recording, whether to increase compression ratio, or whether to delete a file pre-stored in the recording medium to continue the recording.

The system and method further perform the operation of canceling the reservation recording when a command for canceling the reservation recording is input. The system and method further store data to the recording medium by increasing the compression ratio for the reservation recording when a command for increasing the compression ratio is input, and perform reservation recording in the recording space secured by deleting the file pre-stored in the recording medium when a command for deleting the recorded file is input after the storage capacity left in the recording medium is consumed.

### BRIEF DESCRIPTION OF THE DRAWINGS

The above-mentioned objects and features of the present invention will be more apparent from the following description of the preferred embodiments of the present invention with reference to the appended drawings, in which:

FIG. 1 is a block diagram showing a conventional AV system;

FIG. 2 is a flow chart showing an example of a method for improving the use a recording medium of an AV system according to an embodiment of the present invention;

FIG. 3 is a view showing an example of a file system of a hard disk; and

FIG. 4 is a flow chart showing an example of a method for improving the use of a recording medium of an AV system according to another embodiment of the present invention.

### DETAILED DESCRIPTION OF THE PREFERRED EMBODIMENTS

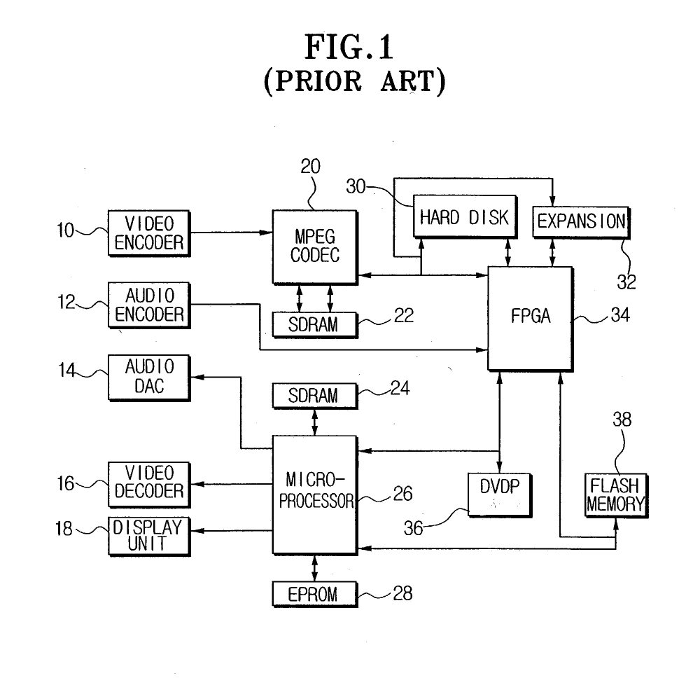

FIG. 1 is a block diagram schematically showing an example of a conventional AV system.

Referring to FIG. 1, a video encoder 10 and a video decoder 16 are used to process video signals, and an audio ADC (analog to digital converter) 12 and an audio DAC (digital to analog converter) 14 are used to process audio signals. In addition, a DVDP (digital video disc player) 36 is present to read a DVD.

An MPEG CODEC 20, for example, is used for compression encoding and decoding of the video and audio signals, and an expansion module 32 is used for expansion, such as coupling to a new device.

A display unit 18 is used to display certain status information, such as control information. FPAG (field-programmable gate array) 34 is, for example, a two-dimensional array comprising a general purpose logic circuit commonly referred to as a cell or a logic block. The FPAG can be programmed, and also can comprise control circuitry.

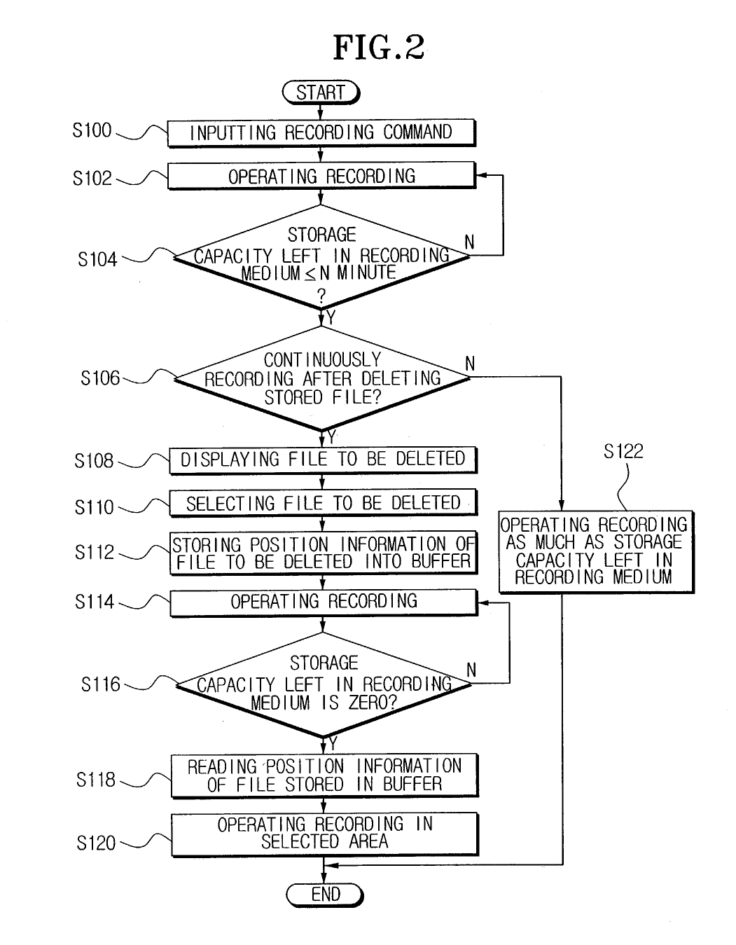

A microprocessor 26 controls the operation of the entire AV system, while SDRAMs 22 and 24, an EPROM 28 and a flash memory 38 are used to store and retrieve data and programs required to control and operate the AV system. Moreover, a hard disk 30, for example, is used as a recording medium to store and retrieve compression encoded video and audio data. FIG. 2 is a flow chart showing an example of a method for improving the use of a recording medium of an AV system according to an embodiment of the present invention. As indicated in step S100, a user inputs a recording command by using, for example, a remote controller, or by pressing a recording button on a control panel of the AV system. The input data is encoded, and a recording operation for recording the data on a recording medium, such as the hard disk 30, is started in step S102.

The microprocessor 26 performs the recording operation, and checks remaining storage capacity of the hard disk 30 regularly. At this time, the remaining storage capacity is calculated as units of data amount (e.g., bytes) and time. For example, when the recorded data uses 0.75 Mbyte per second, and the remaining storage capacity of the hard disk is 225 Mbyte, then the storage capacity remaining is 225 Mbyte and 300 seconds of recording time. The remaining storage capacity of the hard disk 30 is compared with a time value set in advance, and it is determined in step S104 whether the remaining storage capacity is greater or less than the set time value. When the remaining storage capacity of the hard disk 30 is greater than the set time value, the recording operation is continued in step S102. However, when the remaining storage capacity of the hard disk 30 becomes less than the set time value during the recording operation, the processing proceeds to step S106 where the display unit 18 displays a question asking the user whether to delete files previously recorded on the hard disk 30 and continue the recording operation. When the user does not want to delete a file previously recorded on the recoding medium, the recording continues until the remaining storage capacity of the hard disk 30 is consumed. When the storage capacity of the hard disk 30 is all used up, the recording operation is stopped in step S122. However, when the user chooses in step S106 to delete the recorded file and continue the recording operation, a file list recorded on the hard disk 30 is displayed on the display unit 18 in step S108. The user selects a file to be deleted from the file list displayed on the display unit 18 in step S110. The amount of storage capacity secured by deleting a file of the hard disk 30 is expressed as in units of Kbyte and time, and the user is allowed to secure enough recording space.

Position information of the file to be deleted is then stored into a buffer in step S12. In this example, the position information of the file to be deleted is stored in an FAT (file allocation table), and the storage of the data is performed in units referred to as clusters.

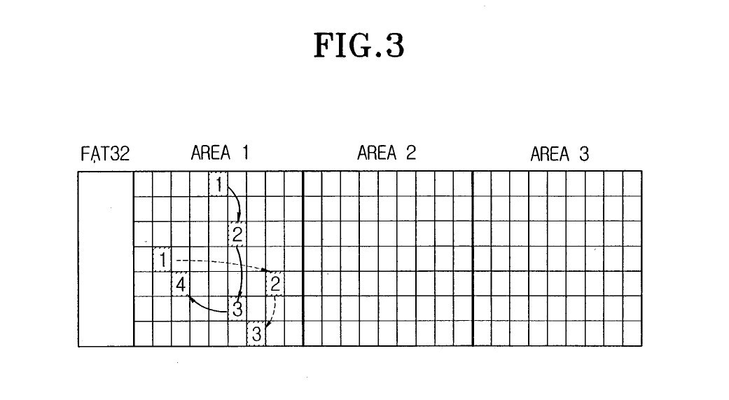

An example of the structure of the cluster unit of the hard disk is shown in FIG. 3, as well as the use of an FAT, such as FAT 32 which is used in DSR2 and Windows® 98. As can further be appreciated by one skilled in the art, FAT 32 is a filing system that has been improved from FAT 16 used in DOS and in Windows® 3.1 and 95.

FIG. 3 shows the case that the components of file A are shown as being connected by a solid line, and the components of file B are shown as being connected by a dotted line. These components of files A and B are located in area 1, and are stored in more than one cluster (e.g., clusters 1 through 4 for file A, and clusters 1 through 3 for file B) in the hard disk 30, which in this example is divided into three areas. As shown in FIG. 3, when a new file is stored on the hard disk 30, the file is stored in more than one cluster. When the new file is store in several clusters, the clusters do not have to be closed, but rather, the clusters are scattered at various locations in the hard disk 30.

When a new file is stored, an FAT entry having the position and the order of each cluster of the file is configured. When the file is read, the content of the file read from the clusters is configured in order, and the entire content of the file is thus retrieved from the clusters.

Similarly, when a file is deleted, the FAT is referenced. By storing the position information of the file to be deleted, actual deletion of the file is delayed until the file actually needs to be deleted when the storage capacity of the hard disk 30 is completely consumed. Also, delay of the recording operation during the search of the positions at which the file is to be stored can be avoided by referring to FAT.

When the position information of the file to be deleted is stored in the buffer, the recording is continuously operated in step S114. The remaining storage capacity of the recording medium is checked to determine whether it is completely consumed. When there is remaining storage capacity in the recording medium, the recording is continuously performed. When the remaining storage capacity is all used up, the position information of the file stored in the buffer is read, and in step S120, the recording is performed to store portions of the file in the areas in which the file to be deleted currently exists.

Although not explicitly shown in FIG. 2, when the remaining storage capacity of the hard disk 30 is still less than the set time even after a file has been deleted as discussed above, the above steps so that additional files can be deleted, as necessary, while the recording operation is being performed.

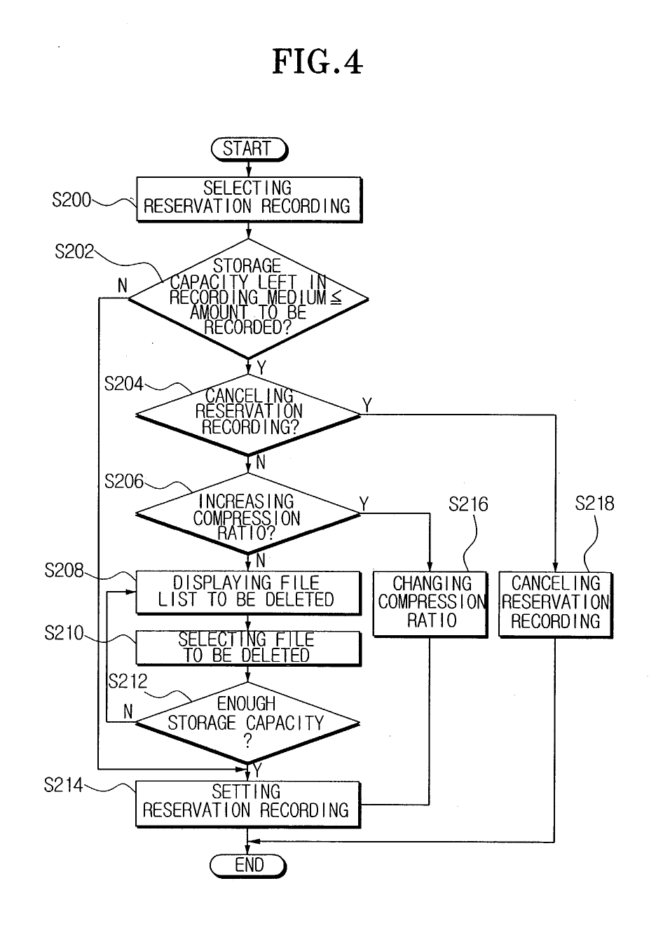

FIG. 4 is a flow chart showing an example of a method for improving the use of a recording medium of an AV system according to another embodiment of the present invention.

Referring to FIG. 4, a user selects reservation recording in step S200, where a particular amount of data is to be recorded on the recording medium or, in other words, a particular space in the recording medium is to be “reserved” for the data to be recorded. The amount of data can be measured in terms of the amount of bytes of data or the length of time necessary to record the data. The remaining capacity of the hard disk 30 used as the recording medium when reservation recording is being performed is determined, and the amount of the data to be recorded are compared in step S202. The magnitude of the data for reservation recording can be calculated considering the start time of the reservation recording, the end time of the reservation time, and the compression rate. When the remaining capacity of the recording medium is greater than the amount of the data to be recorded, the reservation recording setting step is finished, as determined in steps S202 and S214. However, when the remaining capacity of the recording medium is less than the amount of the data to be recorded, the user is asked in step S204 whether to finish the reservation recording. When the user inputs a cancellation command, the reservation recording is finished in step S218.

When the user does not want to cancel the reservation recording in step S204, then the user is asked whether to record by increasing the compression ratio in step S206. When the user wants to continue reservation recording at perhaps a lesser quality due to the increase in compression ratio, the compression ratio is changed and the reservation recording setting is completed in steps S216 and S214. When the user does not want to change the compression ratio, or when the recording cannot be completed in the storage capacity remaining in the hard disk 30 even though the compression ratio is changed to the highest degree, the file list to be deleted among the files stored on the hard disk 30 is displayed in step S208.

The user selects files to be deleted from the file list in step S210. When the user selects the file from the file list, the storage capacity of the hard disk 30 after deleting the file and the amount of the data to be recorded are compared in step S212. After the comparison, when the capacity for the recording is secured, the reservation recording setting is finished in step S214). When the capacity for the recording is not secured after deleting the selected file, files are continuously deleted until the enough capacity for the recording is secured, as indicated in steps S212, S208 and S210.

As shown in FIG. 4, inquiries as to whether to cancel the reservation recording, whether to increase the compression ratio, and the identification of files to be deleted, are consecutively asked. However, it can be more convenient to display the actual content of the hard disk 30 on the display unit at one time to enable the user to select one or more of the files for deletion.

According to the embodiments of the present invention described above, when the storage capacity remaining in the recording medium is less than a predetermined level, the user is notified. Then, the user can delete selected files already stored in the recording medium, so that space for recording can be secured and consecutive recording can be performed.

Furthermore, when reservation recording of the AV system is performed, the recording can be prevented from being stopped due to the space on the disk being totally consumed, because the storage capacity remaining in the recording medium is calculated in advance.

Although the embodiments of the present invention have been described, it will be understood by those skilled in the art that the present invention should not be limited to the described embodiments, but various changes and modifications can be made within the spirit and the scope of the present invention. Accordingly, the scope of the present invention is not limited to the described embodiments but by the following claims and their equivalents.

What is claimed is:

1. A method for improving the use of a recording medium of an AV system, the method comprising:
calculating storage capacity remaining in the recording medium, and recording to the recording medium; and
displaying the storage capacity remaining in the recording medium when the storage capacity remaining in the recording medium becomes less than a predetermined level while the recording is being performed.

2. The method as claimed in claim 1, wherein the displaying step includes:
displaying information to enable a user to decide whether to delete a file already stored in the recording medium; and
recording in the recording space secured by deleting the file already stored in the recording medium when a command for deleting the recorded file is input after the storage capacity remaining in the recording medium has been consumed.

3. The method as claimed in claim 1, wherein at least one of the storage capacity remaining in the recording medium and a recordable temporal duration is displayed in the displaying step.

4. The method as claimed in claim 1, wherein the recording medium includes a hard disk.

5. A method for improving the use of a recording medium of an AV system, the method comprising:
comparing storage capacity remaining in the recording medium and an amount of data to be recorded; and
displaying the storage capacity remaining in the recording medium when the storage capacity left in the recording medium is less than the amount of the data to be recorded.

6. The method according to claim 5, wherein information relating to at least one of the following is displayed in the displaying step: whether to cancel the recording, whether to increase compression ratio, or whether to delete a file pre-stored in the recording medium to continue the recording.

7. The method according to claim 6, further comprising a step of canceling the recording when a command for canceling the recording is input.

8. The method according to claim 6, further comprising a step of storing data to the recording medium by increasing a compression ratio at which the data is compressed when a command for increasing the compression ratio is input.

9. The method according to claim 6, further comprising a step of recording in the recording space secured by deleting a file already stored in the recording medium when a command for deleting the recorded file is input after the storage capacity remaining in the recording medium is consumed.

10. The method according to claim 5, wherein the recording medium includes a hard disk.

11. A system for improving the use of a recording medium of an AV system, the system comprising:
a controller, adapted to calculate storage capacity remaining in the recording medium, and to record to the recording medium; and
a display, adapted to display the storage capacity remaining in the recording medium when the storage capacity remaining in the recording medium becomes less than a predetermined level while the recording is being performed.

12. The system as claimed in claim 11, wherein:
the display is further adapted to display information to enable a user to decide whether to delete a file already stored in the recording medium; and
the controller is further adapted to record in the recording space secured by deleting the file already stored in the recording medium when a command for deleting the recorded file is input after the storage capacity remaining in the recording medium has been consumed.

13. The system as claimed in claim 11, wherein the display is further adapted to display at least one of the storage capacity remaining in the recording medium and a recordable temporal duration.

14. The system as claimed in claim 11, wherein the recording medium includes a hard disk.

15. A system for improving the use of a recording medium of an AV system, the system comprising:
a controller, adapted to compare storage capacity remaining in the recording medium and an amount of data to be recorded; and
a display, adapted to display the storage capacity remaining in the recording medium when the storage capacity left in the recording medium is less than the amount of the data to be recorded.

16. The system according to claim 15, wherein the display is further adapted to display information relating to at least one of the following: whether to cancel the recording, whether to increase compression ratio, or whether to delete a file pre-stored in the recording medium to continue the recording.

17. The system according to claim 16, wherein the controller is further adapted to cancel the recording when a command for canceling the recording is input.

18. The system according to claim 16, wherein the controller is further adapted to store data to the recording medium by increasing a compression ratio at which the data is compressed when a command for increasing the compression ratio is input.

19. The system according to claim 16, wherein the controller is further adapted to record in the recording space secured by deleting a file already stored in the recording medium when a command for deleting the recorded file is input after the storage capacity remaining in the recording medium is consumed.

20. The system according to claim 15, wherein the recording medium includes a hard disk.
